(19) United States
(12) Patent Application Publication
(10) Pub. No.: US 2024/0302552 A1
(43) Pub. Date: Sep. 12, 2024

(54) FIBER OPTIC STRAIN SENSOR AND SEISMIC MONITORING SYSTEM

(71) Applicants: Neubrex Energy Services, Inc., Bellville, TX (US); Neubrex, Co., Ltd., Kobe-shi (JP)

(72) Inventor: Kinzo KISHIDA, Kobe-shi (JP)

(73) Assignees: Neubrex Energy Services, Inc., Bellville, TX (US); Neubrex, Co., Ltd., Kobe-shi (JP)

(21) Appl. No.: 18/599,709

(22) Filed: Mar. 8, 2024

Related U.S. Application Data
(60) Provisional application No. 63/489,002, filed on Mar. 8, 2023.

(51) Int. Cl. G01V 1/22

(52) U.S. Cl. CPC G01V 1/226

(57) ABSTRACT

A seismic monitoring system, including a fiber optic cable defining a central axis and including an axial optical fiber disposed along the central axis, and three helical optical fibers disposed helically around the central axis, said three helical optical fibers being equidistantly spaced apart, a strain sensing unit configured to measure axial strain distribution in the axial optical fiber and in the three helical optical fibers, and a processing server configured to calculate, from the measured axial strain distribution in the axial optical fiber and in the three helical optical fibers, axial strain distribution in the fiber optic cable, pressure distribution in the fiber optic cable, bending distribution in the fiber optic cable in a first direction, and bending distribution in the fiber optic cable in a second direction perpendicular to the first direction.

### CROSS-REFERENCES TO RELATED APPLICATIONS

This application claims the benefit of U.S. Provisional Patent Application No. 63/489,002 filed on Mar. 8, 2023, the entire content of which is incorporated herein by reference for all purposes.

### TECHNICAL FIELD

The present disclosure relates to a surface seismic fiber optic cable and monitoring system.

### BACKGROUND INFORMATION

Distributed Fiber Optic Sensing (DFOS) technology is being developed for a wide variety of uses, including monitoring of seismic activity for, for example, earthquake early-warning systems. Ideally, such systems should indicate the point of origin, as well as the magnitude, of seismic activity. However existing proposed systems employing DFOS technology for this use are infeasible or imprecise.

### SUMMARY

A seismic monitoring system includes a fiber optic cable defining a central axis and including an axial optical fiber disposed along the central axis, and three helical optical fibers disposed helically around the central axis, said three helical optical fibers being equidistantly spaced apart, a strain sensing unit configured to measure axial strain distribution in the axial optical fiber and in the three helical optical fibers, and a processing server configured to calculate, from the measured axial strain distribution in the axial optical fiber and in the three helical optical fibers, axial strain distribution in the fiber optic cable, pressure distribution in the fiber optic cable, bending distribution in the fiber optic cable in a first direction, and bending distribution in the fiber optic cable in a second direction perpendicular to the first direction.

### BRIEF DESCRIPTION OF THE DRAWINGS

Other features and advantages disclosed herein will become more apparent from the following detailed description of exemplary embodiments when read in conjunction with the attached drawings.

FIG. 1 illustrates a partial cut-away perspective view of an embodiment fiber optic cable.

FIG. 2 illustrates a cross-section view of the FIG. 1 fiber optic cable with the helical optical fibers removed.

FIG. 3 illustrates a partial magnification of the FIG. 2 cross-section view.

FIG. 4 illustrates a schematic view of an embodiment of a seismic monitoring system.

FIG. 5 illustrates a schematic view of an embodiment of a hardware processor.

FIG. 6 illustrates a schematic view of a fiber optic cable.

### DETAILED DESCRIPTION

Set forth below with reference to the accompanying drawings is a detailed description of embodiments of a surface seismic fiber optic cable and monitoring system, representing examples of an inventive surface seismic fiber optic cable and monitoring system.

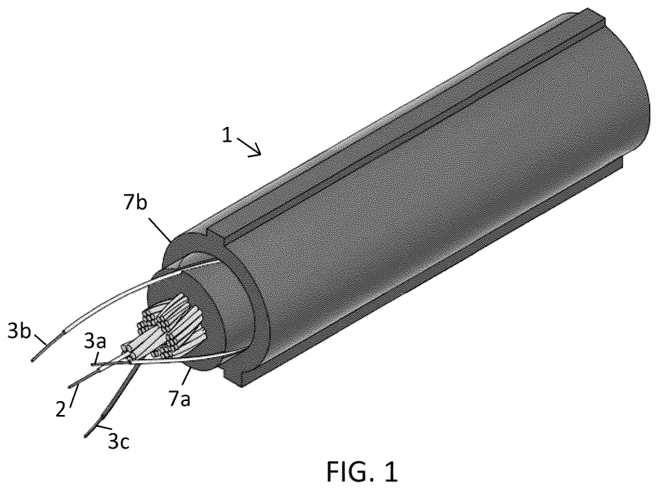

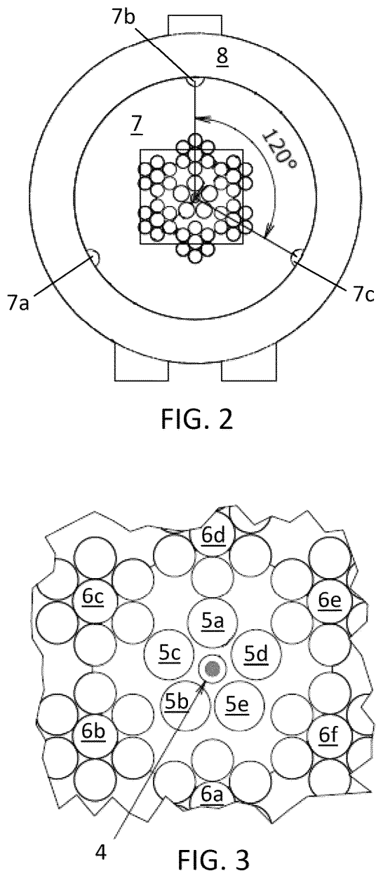

A fiber optic cable 1 according to an embodiment of the present application is illustrated in FIGS. 1-3 and includes an axial optical fiber 2 disposed along the central axis and three equidistantly spaced apart helical optical fibers 3a, 3b and 3c disposed helically around the central axis. In the embodiment, the axial optical fiber 2 and the three helical optical fibers 3a, 3b, and 3c are each coated with a coating 4 of, for example thermoplastic copolyester.

In the embodiment, a plurality of wires 5a-5c are helically wound around the axial optical fiber, and a plurality of wire ropes 6a-6f are helically wound around the plurality of wires. In the embodiment, the wires and wire ropes are made of steel. In the embodiment, a sheath (composed of inner sheath 7a and outer sheath 7b each having a tubular shape) of an elastomeric material, such as rubber, is fitted around the plurality of wire ropes 6a-6f. Three helical grooves 8a-8c are formed in the outer surface of the inner sheath 7a, within which the three helical optical fibers 3a-3c extend. The outer sheath 7b is fitted around the outer surface of the inner sheath 7a and the three helical optical fibers 3a-3c. With this arrangement, pressure, bending, and longitudinal strain on the fiber optical cable 1 as a whole results in corresponding movements of the three helical optical fibers 3a-3c. Furthermore, the axial optical fiber 2 is only susceptible to longitudinal strain.

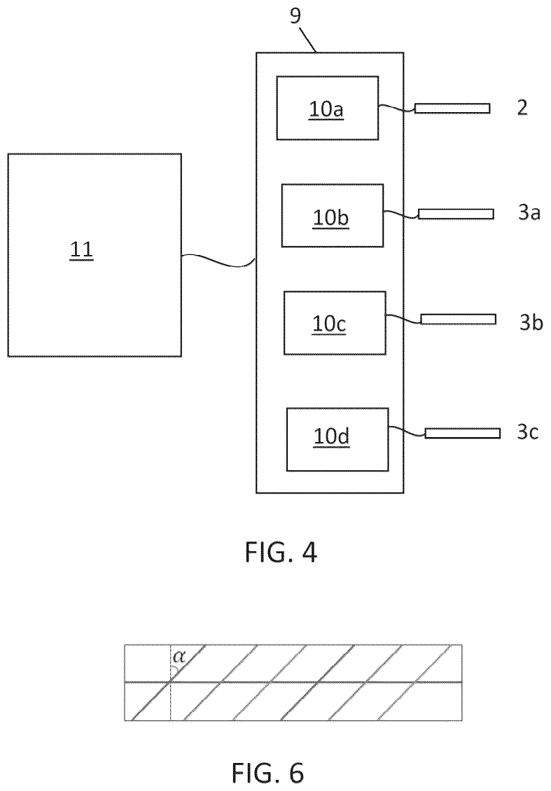

In a fiber optic strain sensor according to the embodiment, known methods are used to measure the axial strain rate at positions along each of the axial optical fiber 2 and the helical optical fibers 3a, 3b and 3c. For example, a known optical fiber sensing technique uses an Optical Time Domain Reflectometer (“OTDR”, hereinafter referred to as an example of an “optical interrogator”) to launch optical pulses into the fiber via a tunable laser of the OTDR, and use the travel time and length of the Rayleigh backscattered light, as detected by a photodetector of the OTDR, to measure the axial strain along the length of the optical fiber. Furthermore, by comparing such measurements to the measured axial strain along the length of the fiber in an initial state, the change in strain over time along the length of the fiber can be determined, and this strain distribution recorded on a time series basis. In the embodiment, a strain sensing unit 9 consists of a respective optical interrogator 10a, 10b, 10c, and 10d associated with the axial optical fiber 2 and the helical optical fibers 3a, 3b and 3c, as illustrated in FIG. 4. As discussed above, in the embodiment, each optical interrogator 10a, 10b, 10c, and 10d is comprised of a respective OTDR including a tunable laser and photodetector. An exemplary suitable Optical Time Domain Reflectometer is the Neubrescope NBX-7000 supplied by Neubrex, Inc.

In a monitoring system according to the embodiment, a processing server 11 receives and uses the strain rate data, acquired by the sensing unit 9, of the respective portions of the optical fibers at each section of the fiber optic cable to determine axial strain distribution in the fiber optic cable, pressure distribution in the fiber optic cable, bending distribution in the fiber optic cable in a first direction, and bending distribution in the fiber optic cable in a second direction perpendicular to the first direction, on a time-series basis. In seismic monitoring applications, by providing a fiber optic cable 1 according to the embodiment in a shallow trench, and monitoring the above-discussed parameters related to the fiber optic cable 1 in real time, and their changes over time, a seismic event and its magnitude and origin can be detected in real time, and information related thereto, including the above-discussed parameters, can be displayed on a display and/or saved in a memory of the processing server 11. In particular, various types of seismic waves traveling the ground will have their forces transmitted to the buried fiber optic cable 1, which can have a length measured in kilometers, thus further enabling triangulation using the above-discussed parameters to determine the strength, direction, and origin of the seismic waves, for example.

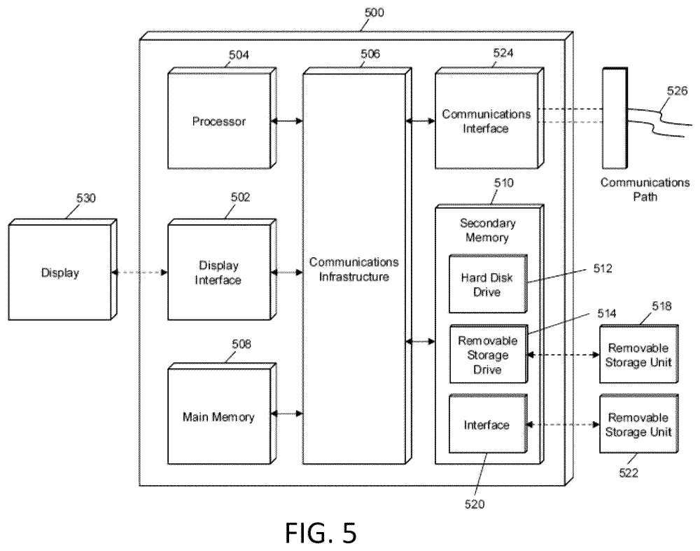

FIG. 5 illustrates a computer system 500 in which embodiments of the present disclosure, or portions thereof, may be implemented as computer-readable code. For example, the processing server 11 of FIG. 4 may be implemented in the computer system 500 using hardware, software, firmware, non-transitory computer readable media having instructions stored thereon, or a combination thereof and may be implemented in one or more computer systems or other processing systems. Hardware, software, or any combination thereof may embody modules and components used to implement the methods discussed herein.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multiprocessor machines. In addition, in some embodiments the order of operations may be rearranged without departing from the spirit of the disclosed subject matter.

Processor device 504 may be a special purpose or a general purpose processor device specifically configured to perform the functions discussed herein. The processor device 504 may be connected to a communications infrastructure 506, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 may also include a main memory 508 (e.g., random access memory, read-only memory, etc.), and may also include a secondary memory 510. The secondary memory 510 may include the hard disk drive 512 and a removable storage drive 514, such as a floppy disk drive, a magnetic tape drive, an optical disk drive, a flash memory, etc.

The removable storage drive 514 may read from and/or write to the removable storage unit 518 in a well-known manner. The removable storage unit 518 may include a removable storage media that may be read by and written to by the removable storage drive 514. For example, if the removable storage drive 514 is a floppy disk drive or universal serial bus port, the removable storage unit 518 may be a floppy disk or portable flash drive, respectively. In one embodiment, the removable storage unit 518 may be non-transitory computer readable recording media.

In some embodiments, the secondary memory 510 may include alternative means for allowing computer programs or other instructions to be loaded into the computer system 500, for example, the removable storage unit 522 and an interface 520. Examples of such means may include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 500 may also include a communications interface 524. The communications interface 524 may be configured to allow software and data to be transferred between the computer system 500 and external devices. Exemplary communications interfaces 524 may include a modem, a network interface (e.g., an Ethernet card), a communications port, a PCMCIA slot and card, etc. Software and data transferred via the communications interface 524 may be in the form of signals, which may be electronic, electromagnetic, optical, or other signals as will be apparent to persons having skill in the relevant art. The signals may travel via a communications path 526, which may be configured to carry the signals and may be implemented using wire, cable, fiber optics, a phone line, a cellular phone link, a radio frequency link, etc.

The computer system 500 may further include a display interface 502. The display interface 502 may be configured to allow data to be transferred between the computer system 500 and external display 530. Exemplary display interfaces 502 may include high-definition multimedia interface (HDMI), digital visual interface (DVI), video graphics array (VGA), etc. The display 530 may be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 508 and secondary memory 510, which may be memory semiconductors (e.g., DRAMs, etc.). These computer program products may be means for providing software to the computer system 500. Computer programs (e.g., computer control logic) may be stored in the main memory 508 and/or the secondary memory 510. Computer programs may also be received via the communications interface 524. Such computer programs, when executed, may enable computer system 500 to implement the present methods as discussed herein. In particular, the computer programs, when executed, may enable processor device 504 to implement the methods discussed herein. Accordingly, such computer programs may represent controllers of the computer system 500. Where the present disclosure is implemented using software, the software may be stored in a computer program product and loaded into the computer system 500 using the removable storage drive 514, interface 520, and hard disk drive 512, or communications interface 524.

The processor device 504 may comprise one or more modules or engines configured to perform the functions of the computer system 500. Each of the modules or engines may be implemented using hardware and, in some instances, may also utilize software, such as corresponding to program code and/or programs stored in the main memory 508 or secondary memory 510. In such instances, program code may be compiled by the processor device 504 (e.g., by a compiling module or engine) prior to execution by the hardware of the computer system 500. For example, the program code may be source code written in a programming language that is translated into a lower level language, such as assembly language or machine code, for execution by the processor device 504 and/or any additional hardware components of the computer system 500. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed herein.

To determine axial strain distribution in the fiber optic cable, pressure distribution in the fiber optic cable, bending distribution in the fiber optic cable in a first direction, and bending distribution in the fiber optic cable in a second direction perpendicular to the first direction, the processing server 11 performs the following calculations. Assuming that ε_{f}⁰ represents strain in the optical fiber 2 and ε_{f}¹, ε_{f}², ε_{f}³ represent strains in the helical optical fibers 3a, 3b and 3c, the relationship between the pure axial strain εₐₓᵢₐₗ in the fiber optic cable 1 and the corresponding strains in the respective optical fibers are represented by the following equations:

$${ε}_{f}^{0} = {ε}_{axial}$$

$${ε}_{f}^{1} = {ε}_{f}^{2} = {ε}_{f}^{3} = {ε}_{axial} {sin}^{2} α$$

where a is the helical pitch angle (i.e., wrapping angle) of the helical optical fibers 3a, 3b and 3c, as illustrated in FIG. 6.

Additionally, the relationship between the strain due to radial pressure on the fiber optic cable 1 (hoop strain εₕₒₒₚ) at a particular cross-section and the corresponding strains in the optical fibers at the particular cross-section is represented by the following equations:

$${ε}_{f}^{0} = 0$$

$${ε}_{f}^{1} = {ε}_{f}^{2} = {ε}_{f}^{3} = {ε}_{hoop} {cos}^{2} α$$

Here, the relationship between the hoop strain εₕₒₒₚ and the pressure P is proportional according to the following equation: where k is a force constant dependent on the materials and geometry of the fiber optic cable:

k P=εₕₒₒₚ

Furthermore, the relationship between the perpendicular bending curvatures Kₓ, K_{y} in the fiber optic cable 1 at a particular cross-section and the corresponding strains in the optical fibers at the particular cross-section is represented by the following equations:

$${ε}_{f}^{0} = 0$$

$${ε}_{f}^{i} = - {κ}_{x} r sin {ϕ}^{i} . {sin}^{2} α - {κ}_{y} r cos {ϕ}^{i} . {sin}^{2} α , i = 1 , 2 , 3$$

where r is the helical wrapping radius of the helical optical fibers 3a, 3b, and 3c, and ϕⁱ is the azimuth angle of the fiber i in the particular cross-section, as shown in FIG. 3. For example, the azimuth angle ϕⁱ is 0° for the optical fiber in groove 7b, 120° for the optical fiber in groove 7c, and 240° for the optical fiber in groove 7c, at the illustrated cross-section of FIG. 3.

Taken together, the strain in each optical fiber at a particular cable cross-section/coordinate will be as follows:

$${ε}_{f}^{0} = {ε}_{a xial}$$

$${ε}_{f}^{i} = {ε}_{axial} {sin}^{2} α + {ε}_{hoop} {cos}^{2} α - {κ}_{x} r sin {ϕ}^{i} {sin}^{2} α - {κ}_{y} r cos {ϕ}^{i} {sin}^{2} α , i = 1 , 2 , 3$$

Furthermore, from the above equations, the relationship between a solution vector s (axial strain, pressure, and bending in two directions) and the fiber strains ε_{f} can be written as follows using coefficient matrix:

$$( \begin{matrix}{ε}_{f}^{0} \\ {ε}_{f}^{1} \\ {ε}_{f}^{2} \\ {ε}_{f}^{3}\end{matrix} ) = [ \begin{matrix}1 & 0 & 0 & 0 \\ {sin}^{2} α & k {cos}^{2} α & - r sin {ϕ}^{1} {sin}^{2} α & - r cos {ϕ}^{1} {sin}^{2} α \\ {sin}^{2} α & k {cos}^{2} α & - r sin {ϕ}^{2} {sin}^{2} α & - r cos {ϕ}^{2} {sin}^{2} α \\ {sin}^{2} α & k {cos}^{2} α & - r sin {ϕ}^{3} {sin}^{2} α & - r cos {ϕ}^{3} {sin}^{2} α\end{matrix} ] ( \begin{matrix}{ε}_{z} \\ P \\ {κ}_{x} \\ {κ}_{y}\end{matrix} )$$

The inverse of this coefficient matrix is transfer matrix T, which would have the following relationship between the solution vector and the fiber strains:

$$( \begin{matrix}{ε}_{z} \\ P \\ {κ}_{x} \\ {κ}_{y}\end{matrix} ) = [ \begin{matrix}{T}_{11} & {T}_{12} & {T}_{13} & {T}_{14} \\ {T}_{21} & {T}_{22} & {T}_{23} & {T}_{24} \\ {T}_{31} & {T}_{32} & {T}_{33} & {T}_{34} \\ {T}_{41} & {T}_{42} & {T}_{43} & {T}_{44}\end{matrix} ] ( \begin{matrix}{ε}_{f}^{0} \\ {ε}_{f}^{1} \\ {ε}_{f}^{2} \\ {ε}_{f}^{3}\end{matrix} )$$

$$s = T {ε}_{f}$$

Furthermore, considering a moving average window l with weight profile w(s), the fiber strains are calculated as follows:

$${ε}_{f}^{0} = \frac{1}{l} {\int }_{l} w ( s ) {ε}_{axial} ds$$

$${ε}_{f}^{i} = \frac{1}{l} {\int }_{l} w ( s ) [ {ε}_{a xial} {sin}^{2} α + {ε}_{h o o p} {cos}^{2} α - {κ}_{x} r sin {ϕ}^{i} {sin}^{2} α - {κ}_{y} r cos {ϕ}^{i} {sin}^{2} α ] d s , i = 1 , 2 , 3$$

Here, the weight (w) accounts for the window shape in the weighted moving average equation. For example, for boxcar, the moving average w(s)=1, and for Gaussian, w(s) represents bell curve. Furthermore, s is the integral variable of distance along the optical cable, and I is the span of the integration. Calculating these strains as a moving average, rather than instantaneously at each point, can permit more accurate replication of the physical phenomena.

Finally, using a least squares approach, the entire cable length is discretized into nodes, each node having a solution vector sₜ:

$$s = ( \begin{matrix}{s}_{1} \\ {s}_{2} \\ ⋮ \\ {s}_{n}\end{matrix} ) , {s}_{i} = ( \begin{matrix}{ε}_{z}^{( i )} \\ {P}^{( i )} \\ {κ}_{x}^{( i )} \\ {κ}_{y}^{( i )}\end{matrix} )$$

The following calculations will achieve the least squares objective of min∥ε_{f}^{m}−ε_{f}∥²:

$$\frac{d}{d s} {( {ε}_{f}^{m} - {ε}_{f} )}^{2} = 0$$

$$\frac{d}{d s} {( {ε}_{f}^{m} - A s )}^{2} = 0$$

$$2 ( A s - {ε}_{f}^{m} ) A = 0$$

$${A}^{T} A s - {A}^{T} {ε}_{f}^{m} = 0$$

$$s = {( {A}^{T} A )}^{- 1} {A}^{T} {ε}_{f}^{m}$$

Where A is the coefficient matrix after taking the moving average over the span I:

$${\overline{ε}}_{f} = Ts$$

$${ε}_{f} = \frac{1}{l} {\int }_{l} w ( s ) {\overline{ε}}_{f} ( s ) ds$$

$${ε}_{f} = A s$$

ε̅_̅{̅f̅}̅=fiber strain before moving average
ε_{f}=fiber strain after moving average

$$s = {( {A}^{T} A )}^{- 1} {A}^{T} {ε}_{f}^{m}$$

Performing the least squares calculation on the moving averaged strains is performed because an exact inversion solution is not possible/practical.

As discussed above, in the embodiment, the hardware processor 11 is programmed to perform calculations according to the foregoing to determine axial strain distribution in the fiber optic cable, pressure distribution in the fiber optic cable, bending distribution in the fiber optic cable in a first direction, and bending distribution in the fiber optic cable in a second direction perpendicular to the first direction, on a time series basis, and output said results to a display, such as corresponding graphs and charts, or for further analysis, to monitor for seismic events.

It will be appreciated by those skilled in the art that the disclosure herein can be embodied in other specific forms without departing from the spirit or essential characteristics thereof. The presently-disclosed embodiments are therefore considered in all respects to be exemplary and not restricted. The scope of the invention is indicated by the appended claims rather than the foregoing description and all changes that come within the meaning and range and equivalence thereof are intended to be embraced therein.

What is claimed is:

1. A fiber optic strain sensor, comprising:
a fiber optic cable defining a central axis and including an axial optical fiber disposed along the central axis, and three helical optical fibers disposed helically around the central axis, said three helical optical fibers being equidistantly spaced apart; and
a strain sensing unit configured to measure axial strain distribution in the axial optical fiber and in the three helical optical fibers.

2. The fiber optic strain sensor of claim 1, wherein the axial optical fiber and the three helical optical fibers are each coated with thermoplastic copolyester.

3. The fiber optic strain sensor of claim 1, wherein the fiber optic cable further comprises a plurality of wires helically wound around the axial optical fiber.

4. The fiber optic strain sensor of claim 3, wherein the fiber optic cable further comprises a plurality of wire ropes helically wound around the plurality of wires.

5. The fiber optic strain sensor of claim 1, wherein the fiber optic cable further comprises a sheath on which the three helical optical fibers are mounted.

6. The fiber optic strain sensor of claim 5, wherein the sheath is made of an elastomeric material.

7. A seismic monitoring system, comprising:
the fiber optic strain sensor of claim 1; and
a processing server configured to calculate, from the measured axial strain distribution in the axial optical fiber and in the three helical optical fibers, axial strain distribution in the fiber optic cable, pressure distribution in the fiber optic cable, bending distribution in the fiber optic cable in a first direction, and bending distribution in the fiber optic cable in a second direction perpendicular to the first direction.

8. The seismic monitoring system of claim 7, wherein the axial optical fiber and the three helical optical fibers are each coated with thermoplastic copolyester.

9. The seismic monitoring system of claim 7, wherein the fiber optic cable further comprises a plurality of wires helically wound around the axial optical fiber.

10. The seismic monitoring system of claim 9, wherein the fiber optic cable further comprises a plurality of wire ropes helically wound around the plurality of wires.

11. The seismic monitoring system of claim 7, wherein the fiber optic cable further comprises a sheath on which the three helical optical fibers are mounted.

12. The seismic monitoring system of claim 11, wherein the sheath is made of an elastomeric material.

13. A method of monitoring for seismic activity, comprising:
measuring axial strain distribution in an axial optical fiber and in three helical optical fibers of a buried fiber optic cable; and
calculating, from the measured axial strain distribution in the axial optical fiber and in the three helical optical fibers, axial strain distribution in the fiber optic cable, pressure distribution in the fiber optic cable, bending distribution in the fiber optic cable in a first direction, and bending distribution in the fiber optic cable in a second direction perpendicular to the first direction.
